(19) United States
(12) Patent Application Publication
(10) Pub. No.: US 2026/0095783 A1
(43) Pub. Date: Apr. 2, 2026

(54) SENSING SETUP METHOD, ELECTRONIC DEVICE, AND STORAGE MEDIUM

(71) Applicant: BEIJING XIAOMI MOBILE SOFTWARE CO., LTD., Beijing (CN)

(72) Inventor: Xiandong DONG, Beijing (CN)

(73) Assignee: BEIJING XIAOMI MOBILE SOFTWARE CO., LTD., Beijing (CN)

(21) Appl. No.: 19/112,236

(22) PCT Filed: Sep. 20, 2022
(86) PCT No.: PCT/CN2022/119933

§ 371 Date: Mar. 14, 2025

(51) Int. Cl. H04W 24/02

(52) U.S. Cl. CPC H04W 24/02

(57) ABSTRACT

Methods for sensing measurement setup, apparatuses and non-transitory computer-readable storage media thereof are provided. In one method for sensing measurement setup, a sensing by proxy (SBP) responder may send a measurement setup (MS) request frame to a sensing responder. The MS request frame may include target time information participating in TB sensing, and the target time information is selected by the SBP responder from available time information provided by an SBP initiator.

### CROSS-REFERENCE TO RELATED APPLICATIONS

The present application is the U.S. National Stage of International Application No. PCT/CN2022/119933, filed on Sep. 20, 2022, the content of which is incorporated by reference herein in its entirety for all purposes.

### TECHNICAL FIELD

The embodiments of the present disclosure relate to the field of mobile communication technology. Specifically, the embodiments of the present disclosure relate to a sensing measurement setup method, an electronic device, and a storage medium.

### BACKGROUND

With the rapid development of mobile communication technology, wireless fidelity (Wi-Fi) technology has made great progress in transmission rate and throughput. Among the Wi-Fi technologies currently being studied, wireless local area network (WLAN) sensing technology may be supported, for example, in application scenarios such as location discovery, proximity detection, and presence detection in dense environments (such as home environments and corporate environments).

In the WLAN Sensing process, the identities of station (STA) and access point device (AP) are usually interchangeable. For example, both can be used as initiator devices (Sensing Initiator or Sensing Transmitter). When used as a Sensing Initiator or Sensing Transmitter, AP can communicate with multiple STAs at the same time, but STA does not have the above functions and can only communicate one-to-one with a single sensing responder. On the one hand, it causes a waste of spectrum resources, and on the other hand, it causes an increase in latency. For communication scenarios with high latency requirements, it may not meet the latency requirements. In order to solve this problem, a method of using AP as a proxy STA to perform WLAN sensing measurement, namely Sensing By Proxy (SBP), is proposed.

In the SBP scenario, the AP acting as a proxy STA initiates a Triggered Based (TB) sensing measurement and sends a Measurement Setup (MS) request frame to the sensing responder.

### SUMMARY

According to an aspect of the embodiments of the present disclosure, there is provided a sensing measurement setup method, performed by a sensing by proxy SBP responder, including:
sending a measurement setup MS request frame to a sensing responder, where the MS request frame includes target time information for participating in TB sensing measurement, and the target time information is selected by the SBP responder from available time information provided by an SBP initiator.

According to another aspect of the embodiments of the present disclosure, there is provided a sensing measurement setup method, performed by a sensing by proxy SBP initiator, including:
sending an SBP request frame to an SBP responder, carrying available time information of TB sensing measurement in the SBP request frame, instructing the SBP responder to select target time information from the available time information and carry the target time information in a measurement setup MS request frame and send it to a sensing responder.

According to another aspect of the embodiments of the present disclosure, there is provided a sensing measurement setup method, performed by a sensing responder, including:
receiving a measurement setup MS request frame sent by an SBP responder; where the MS request frame includes target time information for participating in TB sensing measurement, and the target time information is selected by the SBP responder from the available time information provided by an SBP initiator.

According to another aspect of the embodiments of the present disclosure, there is provided an electronic device, which is a sensing by proxy SBP responder, including:
a MS request sending module, configured to send a measurement setup MS request frame to a sensing responder; where the MS request frame includes target time information for participating in TB sensing measurement, and the target time information is selected by the SBP responder from available time information provided by an SBP initiator.

According to another aspect of the embodiments of the present disclosure, there is provided an electronic device, which is a sensing by proxy SBP initiator, including:
a SBP request sending module, configured to send an SBP request frame to an SBP responder, carrying available time information of TB sensing measurement in the SBP request frame, instructing the SBP responder to select target time information from the available time information and carry the target time information in a measurement setup MS request frame and send it to a sensing responder.

According to another aspect of the embodiments of the present disclosure, there is provided an electronic device, which is a sensing responder, including:
a MS request receiving module, configured to receive a measurement setup MS request frame sent by an SBP responder; where the MS request frame includes target time information for participating in TB sensing measurement, and the target time information is selected by the SBP responder from available time information provided by an SBP initiator.

The embodiments of the present disclosure also provide an electronic device, including a memory, a processor, and a computer program stored in the memory and executable on the processor, where the processor implements the method according to one or more embodiments of the present disclosure when executing the program.

The embodiments of the present disclosure also provide a computer-readable storage medium, on which a computer program is stored, where the computer program implements the method according to one or more embodiments of the present disclosure when executed by the processor.

Additional aspects and advantages of the embodiments of the present disclosure will be partially given in the following description, which will become apparent from the following description or understood through the practice of the present disclosure.

### BRIEF DESCRIPTION OF THE DRAWINGS

In order to more clearly illustrate the technical solution of the embodiment of the present disclosure, the following will briefly introduce the drawings required for use in the description of the embodiment of the present disclosure. Obviously, the drawings in the following description are only some embodiments of the present disclosure. For those skilled in the art, other drawings can also be obtained based on these drawings without inventive labor.

FIG. 1 is one of flow charts of a sensing measurement setup method provided by an embodiment of the present disclosure;

FIG. 2 is one of schematic diagrams of a first example of an embodiment of the present disclosure;

FIG. 3 is a second schematic diagram of the first example of the embodiment of the present disclosure;

FIG. 4 is a third schematic diagram of the first example of the embodiment of the present disclosure;

FIG. 5 is a second flow chart of the sensing measurement setup method provided by the embodiment of the present disclosure;

FIG. 6 is a third flow chart of the sensing measurement setup method provided by the embodiment of the present disclosure;

FIG. 7 is one of structural schematic diagrams of an electronic device provided by an embodiment of the present disclosure;

FIG. 8 is a second structural schematic diagram of the electronic device provided by the embodiment of the present disclosure;

FIG. 9 is a third structural schematic diagram of the electronic device provided by the embodiment of the present disclosure;

FIG. 10 is a fourth structural schematic diagram of the electronic device provided by the embodiment of the present disclosure.

### DETAILED DESCRIPTION

In the embodiments of the present disclosure, the term “and/or” describes the association relationship of the associated objects, indicating that there may be three relationships. For example, A and/or B can represent: A exists alone, A and B exist at the same time, and B exists alone. The character “/” generally indicates that the objects associated before and after are in an “or” relationship.

In the embodiments of the present disclosure, the term “multiple” refers to two or more, and other quantifiers are similar.

Here, the example embodiments will be described in detail, and examples thereof are shown in the accompanying drawings. Unless otherwise indicated when the following description refers to the drawings, the same numbers in different drawings represent the same or similar elements. The embodiments described in the following example embodiments do not represent all embodiments consistent with the present disclosure. Instead, they are merely examples of devices and methods consistent with some aspects of the present disclosure as detailed in the attached claims.

The terms used in the present disclosure are for the purpose of describing specific embodiments only and are not intended to limit the present disclosure. The singular forms “a”, “an”, “said” and “the” used in the present disclosure and the attached claims are also intended to include the plural forms unless the context clearly indicates otherwise. It should also be understood that the term “and/or” used herein refers to and includes any or all possible combinations of one or more associated listed items.

It should be understood that although the terms first, second, third, etc. may be used in the present disclosure to describe various information, such information should not be limited to these terms. These terms are only used to distinguish the same type of information from each other. For example, without departing from the scope of the present disclosure, the first information may also be referred to as the second information, and similarly, the second information may also be referred to as the first information. Depending on the context, for example, the word “if” used herein may be interpreted as “at . . . ” or “when . . . ” or “in response to determining”.

The technical solutions in the embodiments of the present disclosure will be clearly and completely described below in conjunction with the drawings in the embodiments of the present disclosure. Obviously, the described embodiments are only part of the embodiments of the present disclosure, not all of the embodiments. Based on the embodiments in the present disclosure, all other embodiments obtained by those skilled in the art without inventive work are within the scope of protection of the present disclosure.

The embodiments of the present disclosure provide a sensing measurement setup method, an electronic device, and a storage medium to provide a format of an MS request frame.

The method and the device are based on the same application concept. Since the principles of solving the problem by the method and the device are similar, the implementation of the device and the method can refer to each other, and the repeated parts will not be repeated.

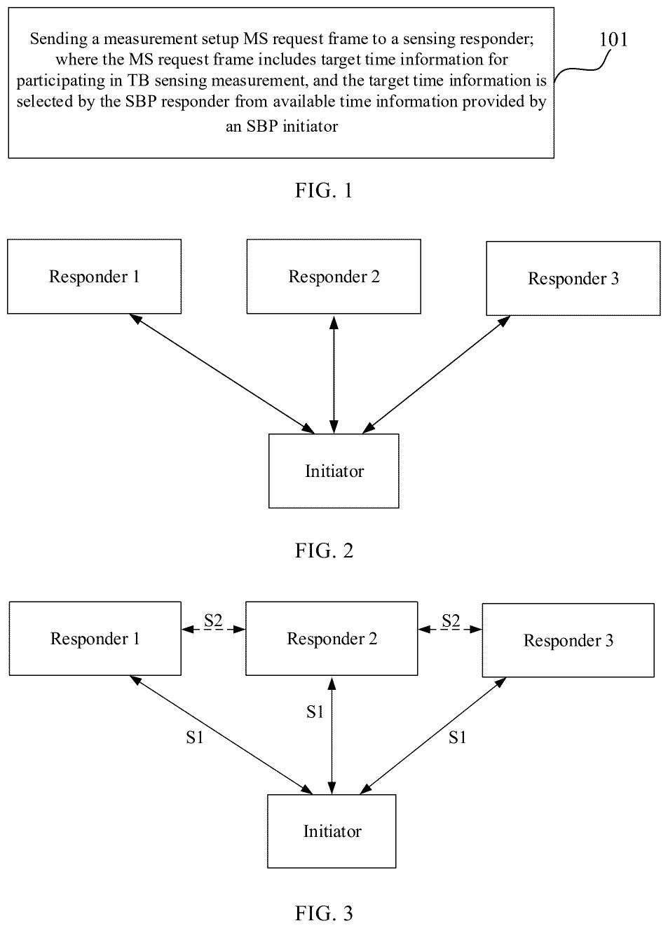

As shown in FIG. 1, the embodiment of the present disclosure provides a sensing measurement setup method. Alternatively, the method can be applied to a sensing by proxy SBP responder. The method may include the following steps:

Step 101, sending a measurement setup MS request frame to a sensing responder; where the MS request frame includes target time information for participating in TB sensing measurement, and the target time information is selected by the SBP responder from available time information provided by an SBP initiator.

As a first example, referring to FIG. 2 to FIG. 4, the architecture of WLAN Sensing and the WLAN Sensing process applied by the sensing measurement setup method provided by the embodiment of the present disclosure are first introduced.

FIG. 2 shows a schematic diagram of the architecture of a WLAN Sensing (process). A sensing initiator (or initiator) initiates WLAN Sensing (for example, initiates a WLAN sensing session), and there may be multiple sensing responders (or sensing receivers) or responders responding to it, as shown by responder 1, responder 2, and responder 3 in FIG. 2. When the sensing initiator initiates WLAN Sensing, multiple associated or unassociated sensing responders of WLAN Sensing may respond.

Referring to FIG. 3, the sensing initiator communicates with the sensing responder through a communication connection, as shown by a communication connection S1. The sensing responders communicate with each other through a communication connection S2.

Each sensing initiator may be a client. Each sensing responder (in this example, sensing responder 1 to sensing responder 3) may be a station (STA) or an access point (AP). In addition, STA and AP can assume multiple roles in the WLAN sensing process. For example, in the WLAN sensing process, STA can also serve as a sensing initiator, and the sensing initiator may be a sensing transmitter, a sensing receiver, or both, or neither. In the WLAN sensing process, the sensing responder may also be a sensing transmitter, a sensing receiver, or both.

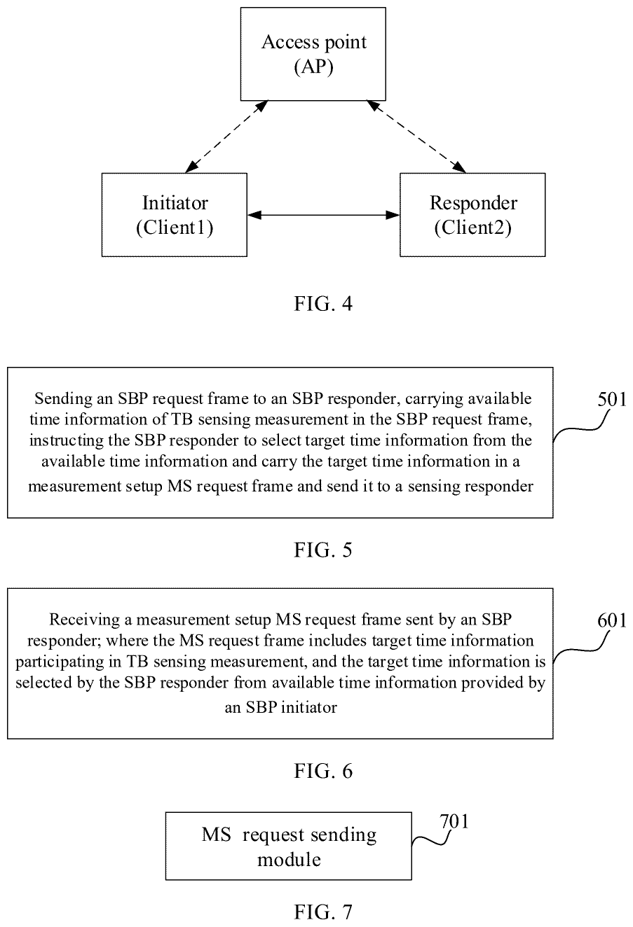

As another architecture, as shown in FIG. 4, both of the sensing initiator and the sensing responder can also be clients, and the two can communicate by connecting to the same access point (AP). Client 1 in FIG. 4 is the sensing initiator, and Client 2 is the sensing responder.

In general, the WLAN sensing process usually includes a Triggered Based Sounding (TB) method and a Non-TB based sensing method. Specifically, the TB sensing measurement method is that the AP is the Initiator or Transmitter, and the Non-TB sensing measurement method is that the STA is the Initiator or Transmitter.

Further, the SBP responder initiates WLAN sensing measurement as an SBP proxy, and the initiated WLAN sensing measurement is a TB sensing measurement, which is divided into NDPA Sounding (downlink DL) sensing and trigger frame Sounding (uplink UL) processes.

In the SBP scenario, the SBP Initiator provides multiple pieces of available time information to the SBP Responder. The SBP Responder selects a piece of target time information from the available time information provided by the SBP Initiator as the time window of this TB sensing measurement (process), and sends an MS request frame to the sensing responder participating in the TB sensing measurement, and carries the target time information in the MS request frame to indicate the target time information to the sensing responder, and then sets up the TB sensing measurement with the sensing responder within the target time information.

Alternatively, the available time information and the target time information may be in the form of a time window. The time window may include a preset number of time units (TUs), and each time unit may be a preset time length, for example, 10 milliseconds (ms).

Alternatively, the sensing responder participating in the TB sensing measurement includes the SBP initiator and/or other STAs.

In the embodiment of the present disclosure, the SBP responder sends a measurement setup MS request frame to the sensing responder. The MS request frame carries the target time information for participating in the TB sensing measurement, and the target time information is selected by the SBP responder from the available time information provided by the SBP initiator. The target time information for participating in the TB sensing measurement is indicated through the MS request frame to improve the SBP process and the format of the MS request frame.

The embodiment of the present disclosure provides a sensing measurement setup method. Alternatively, the method can be applied to a sensing by proxy SBP responder. The method may include the following steps:
receiving an SBP request frame sent by an SBP initiator;
acquiring available time information of the TB sensing measurement from the SBP request frame; and
selecting target time information for participating in the TB sensing measurement from the available time information, and send a measurement setup MS request frame to the sensing responder, where the MS request frame includes the target time information.

When the SBP Responder receives the SBP request frame, it acquires multiple (at least two) pieces of available time information carried in the SBP request frame. The SBP Responder selects a piece of target time information from the available time information provided in the SBP request frame as the time window of this TB sensing measurement (process), and sends an MS request frame to the sensing responder participating in the TB sensing measurement, and carries the target time information in the MS request frame to indicate the target time information to the sensing responder, and then setups the TB sensing measurement with the sensing responder within the target time information.

The embodiment of the present disclosure provides a sensing measurement setup method. Alternatively, the method can be applied to a sensing by proxy SBP responder. The method may include the following steps:
receiving an SBP request frame sent by an SBP initiator;
acquiring available time information from the SBP request frame and acquiring parameter information of the TB sensing measurement carried in the SBP request frame;
setting up the TB sensing measurement based on the parameter information and determining the MS request frame; where the MS request frame also includes target time information for participating in the TB sensing measurement, and the target time information is selected from the available time information.

When the SBP Responder receives the SBP request frame, on the one hand, it obtains multiple (at least two) pieces of available time information carried in the SBP request frame, and the SBP Responder selects a piece of target time information from the available time information provided in the SBP request frame as the time window of this TB sensing measurement (process). On the other hand, the SBP Responder obtains the parameter information of the TB sensing measurement carried in the SBP request frame, such as the number of STAs participating in the TB sensing measurement, the number of STAs participating in the Null Data Packet Announcement (NDPA sounding) of the TB sensing measurement, or the number of STAs participating in the Trigger Frame TF sounding of the TB sensing measurement and other related parameters. According to the parameter information, the SBP Responder sets up the TB sensing measurement, and determines the MS request frame, and carries the target time information in the MS request frame to indicate the target time information to the sensing responder.

Alternatively, in the embodiment of the present disclosure, before or after setting up the TB sensing measurement according to the parameter information, the method further includes:
sending an SBP response frame to the SBP initiator, and carrying the target time information in the SBP response frame.

Case 1: Before setting up the TB sensing measurement, the SBP responder may send an SBP response frame to the SBP initiator first to indicate the target time information, as shown in the following second example: the SBP responder receives an SBP request frame sent by the SBP initiator;
the SBP responder obtains available time information from the SBP request frame and obtains parameter information of the TB sensing measurement carried in the SBP request frame;
the SBP responder sends an SBP response frame to the SBP initiator, and carries the target time information in the SBP response frame; and
the SBP responder sets up the TB sensing measurement based on the parameter information and determines the MS request frame; where the MS request frame also includes the target time information participating in the TB sensing measurement, and the target time information is selected from the available time information.

Case 2: the SBP responder can also send an SBP response frame to the SBP initiator after setting up the TB sensing measurement, as shown in the third example below:
the SBP responder receives an SBP request frame sent by the SBP initiator;
the SBP responder obtains available time information from the SBP request frame and obtains parameter information of the TB sensing measurement carried in the SBP request frame;
the SBP responder sets up the TB sensing measurement based on the parameter information and determines the MS request frame; where the MS request frame also includes target time information participating in the TB sensing measurement, and the target time information is selected from the available time information; and
the SBP responder sends an SBP response frame to the SBP initiator, and carries the target time information in the SBP response frame.

The embodiment of the present disclosure provides a sensing measurement method. Alternatively, the method can be applied to a sensing by proxy SBP responder. The method may include the following steps:
receiving an SBP request frame sent by an SBP initiator;
acquiring the available time information from the SBP request frame;
selecting target time information for participating in the TB sensing measurement from the available time information, and sending a measurement setup MS request frame to the sensing responder, where the MS request frame includes the target time information;
when the SBP request frame includes multiple TB sensing measurements, the MS request frame includes target time information corresponding to each TB sensing measurement.

In a periodic measurement scenario, for example, in a case where the SBP request frame includes multiple TB sensing measurements (processes), the MS request frame includes target time information corresponding to each TB sensing measurement (process). For example, in a case where the SBP request frame includes 4 TB sensing measurements, the availability window information element in the MS request frame indicates that the 1st, 5th, 7th, and 9th time windows are the target time information corresponding to each TB sensing measurement.

In the embodiment of the present disclosure, the SBP responder sends a measurement setup MS request frame to the sensing responder. The target time information for participating in the TB sensing measurement is carried in the MS request frame, and the target time information is selected by the SBP responder from the available time information provided by the SBP initiator. The target time information for participating in the TB sensing measurement is indicated by the MS request frame to improve the SBP process and the format of the MS request frame.

Referring to FIG. 5, the embodiment of the present disclosure provides a sensing measurement setup method. Alternatively, the method can be applied to a sensing by proxy SBP initiator, and the method may include the following steps:

Step 501, sending an SBP request frame to an SBP responder, carrying available time information of TB sensing measurement in the SBP request frame, instructing the SBP responder to select target time information from the available time information and carry the target time information in a measurement setup MS request frame and send it to a sensing responder.

With respect to the architecture of WLAN Sensing applied to the sensing measurement setup method provided in the embodiment of the present disclosure and the WLAN Sensing process, please refer to the aforementioned first example, and such content will not be repeated here.

In the SBP scenario, the SBP Initiator sends an SBP request frame to the SBP responder. The SBP request frame carries the available time information of the TB sensing measurement, which is used to provide multiple pieces of available time information for the SBP Responder; at the same time, the SBP responder is instructed to select the target time information from the available time information and the target time information is carried in the measurement setup MS request frame and sent to the sensing responder.

The SBP Responder selects a piece of target time information from the available time information provided by the SBP Initiator as the time window of this TB sensing measurement (process) and sends an MS request frame to the sensing responder participating in the TB sensing measurement, and carries the target time information in the MS request frame to indicate the target time information to the sensing responder, and then sets up the TB sensing measurement with the sensing responder within the target time information.

Alternatively, the available time information and the target time information may be in the form of a time window. The time window may include a preset number of time units (TUs), and each time unit may be a preset time length, for example, 10 milliseconds (ms).

Alternatively, the sensing responder participating in the TB sensing measurement includes the SBP initiator and/or other STAs.

In the embodiment of the present disclosure, the SBP initiator sends an SBP request frame to the SBP responder, carries the available time information of the TB sensing measurement in the SBP request frame, instructs the SBP responder to select the target time information from the available time information and carry the target time information in the measurement setup MS request frame to send it to the sensing responder, indicating the target time information participating in the TB sensing measurement through the SBP request frame and the MS request frame, improving the SBP process, and providing the format of the MS request frame.

The embodiment of the present disclosure provides a sensing measurement setup method. Alternatively, the method can be applied to a sensing by proxy SBP initiator. The method may include the following steps:
sending an SBP request frame to an SBP responder, carrying available time information of TB sensing measurement in the SBP request frame, instructing the SBP responder to select target time information from the available time information and carry the target time information in a measurement setup MS request frame and send it to the sensing responder;

The SBP request frame also carries parameter information of the TB sensing measurement, instructing the SBP responder to set up the TB sensing measurement based on the parameter information.

The parameter information includes, for example, the number of STAs participating in the TB sensing measurement, the number of STAs participating in the Null Data Packet Announcement (NDPA sounding) of the TB sensing measurement, or the number of STAs participating in the Trigger Frame TF sounding of the TB sensing measurement and other related parameters. According to the parameter information, the SBP initiator sets up the TB sensing measurement, and determines the MS request frame, and also carries the parameter information of the TB sensing measurement in the SBP request frame, and instructs the SBP responder to set up the TB sensing measurement based on the parameter information.

The embodiment of the present disclosure provides a sensing measurement method. Alternatively, the method can be applied to a sensing by proxy SBP initiator. The method can include the following steps:
sending an SBP request frame to an SBP responder, carrying available time information of TB sensing measurement in the SBP request frame, instructing the SBP responder to select target time information from the available time information and carry the target time information in a measurement setup MS request frame and send it to the sensing responder;
receiving an SBP response frame sent by the SBP responder, and obtaining the target time information carried in the SBP response frame; where the SBP response frame is sent by the SBP responder before or after setting up the TB sensing measurement.

Before setting up the TB sensing measurement, the SBP responder can send an SBP response frame to the SBP initiator first; or the SBP responder can send an SBP response frame to the SBP initiator after setting up the TB sensing measurement. The SBP initiator receives the SBP response frame, obtains the target time information carried in the SBP response frame, and determines the target time information corresponding to the TB sensing measurement.

The embodiment of the present disclosure provides a sensing measurement method. Alternatively, the method can be applied to a sensing by proxy SBP initiator. The method may include the following steps:
sending an SBP request frame to an SBP responder, carrying available time information of TB sensing measurement in the SBP request frame, instructing the SBP responder to select target time information from the available time information and carry the target time information in a measurement setup MS request frame and send it to the sensing responder;
in a case where the SBP request frame includes multiple TB sensing measurements, the MS request frame includes the target time information corresponding to each TB sensing measurement.

In a periodic measurement scenario, for example, in a case where the SBP request frame includes multiple TB sensing measurements (processes), the MS request frame includes target time information corresponding to each TB sensing measurement (process). For example, in a case where the SBP request frame includes 4 TB sensing measurements, the availability window information element in the MS request frame indicates that the 1st, 5th, 7th, and 9th time windows are the target time information corresponding to each TB sensing measurement.

In the embodiment of the present disclosure, the SBP initiator sends an SBP request frame to the SBP responder, carries the available time information of the TB sensing measurement in the SBP request frame, instructs the SBP responder to select the target time information from the available time information and carry the target time information in the measurement setup MS request frame to send it to the sensing responder. The target time information participating in the TB sensing measurement is indicated through the SBP request frame and the MS request frame, thereby improving the SBP process and providing the format of the MS request frame.

Referring to FIG. 6, the embodiment of the present disclosure provides a sensing measurement setup method. Alternatively, the method can be applied to a sensing responder, and the method can include the following steps:

Step 601, receiving a measurement setup MS request frame sent by an SBP responder; where the MS request frame includes target time information participating in TB sensing measurement, and the target time information is selected by the SBP responder from available time information provided by an SBP initiator.

In the SBP scenario, the SBP Initiator provides multiple pieces of available time information to the SBP Responder. The SBP Responder selects a piece of target time information from the available time information provided by the SBP Initiator as the time window of this TB sensing measurement (process), and sends an MS request frame to the sensing responder participating in the TB sensing measurement, and carries the target time information in the MS request frame to indicate the target time information to the sensing responder, and then sets up the TB sensing measurement with the sensing responder within the target time information.

Alternatively, the available time information and the target time information may be in the form of a time window. The time window may include a preset number of time units (TUs), and each time unit may be a preset time length, for example, 10 milliseconds (ms).

Alternatively, the sensing responder participating in the TB sensing measurement includes the SBP initiator and/or other STAs.

Alternatively, in the embodiment of the present disclosure, in a case where the SBP request frame sent by the SBP initiator includes multiple TB sensing measurements, the MS request frame includes the target time information corresponding to each TB sensing measurement.

In a periodic measurement scenario, for example, in a case where the SBP request frame includes multiple TB sensing measurements (processes), the MS request frame includes target time information corresponding to each TB sensing measurement (process). For example, in a case where the SBP request frame includes 4 TB sensing measurements, the availability window information element in the MS request frame indicates that the 1st, 5th, 7th, and 9th time windows are the target time information corresponding to each TB sensing measurement.

In the embodiment of the present disclosure, the sensing responder receives the measurement setup MS request frame sent by the SBP responder; where the MS request frame includes the target time information for participating in the TB sensing measurement, and the target time information is selected by the SBP responder from the available time information provided by the SBP initiator. The target time information for participating in the TB sensing measurement is indicated by the MS request frame to improve the SBP process.

Referring to FIG. 7, based on the same principle as the method provided in the embodiment of the present disclosure, the embodiment of the present disclosure further provides an electronic device. The electronic device is a sensing by proxy SBP responder, and the electronic device includes:
a MS request sending module 701, configured to send a measurement setup MS request frame to a sensing responder; where the MS request frame includes target time information for participating in TB sensing measurement, and the target time information is selected by the SBP responder from available time information provided by an SBP initiator.

Alternatively, in the embodiment of the present disclosure, the electronic device includes:
a first acquiring module, configured to, before the MS request sending module 701 sends the measurement setup MS request frame to the sensing responder,
receive an SBP request frame sent by the SBP initiator; and
acquire the available time information from the SBP request frame.

Alternatively, in the embodiment of the present disclosure, the electronic device includes:
a second acquiring module, configured to, after the first acquiring module receives the SBP request frame sent by the SBP initiator,
acquire parameter information of the TB sensing measurement carried in the SBP request frame; and
set up the TB sensing measurement based on the parameter information and determine the MS request frame.

Alternatively, in an embodiment of the present disclosure, the electronic device includes:
a first sending module, configured to, before or after the second acquiring module sets up the TB sensing measurement based on the parameter information,
send an SBP response frame to the SBP initiator, where the SBP response frame carries the target time information.

Alternatively, in an embodiment of the present disclosure, in a case where the SBP request frame includes multiple TB sensing measurements, the MS request frame includes the target time information corresponding to each TB sensing measurement.

The embodiment of the present disclosure also provides a sensing measurement setup device, which is applied to a sensing by proxy SBP responder, and the device includes:
a MS request frame sending module, configured to send a measurement setup MS request frame to a sensing responder; where the MS request frame includes target time information participating in the TB sensing measurement, and the target time information is selected by the SBP responder from available time information provided by an SBP initiator.

The device also includes other modules of the electronic device in the aforementioned embodiment, which will not be repeated here.

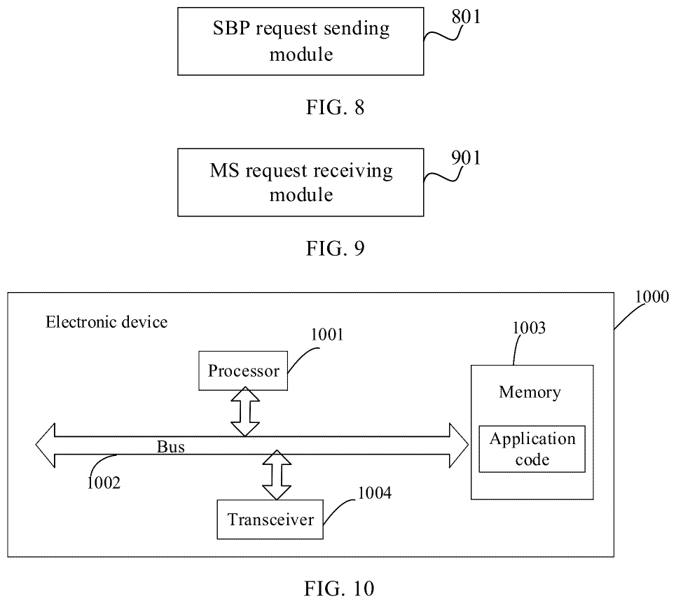

Referring to FIG. 8, based on the same principle as the method provided in the embodiment of the present disclosure, the embodiment of the present disclosure further provides an electronic device. The electronic device is a sensing by proxy SBP initiator, and the electronic device includes:
an SBP request sending module 801, configured to send an SBP request frame to an SBP responder, carry available time information of the TB sensing measurement in the SBP request frame, instruct the SBP responder to select target time information from the available time information and carry the target time information in a measurement setup MS request frame and send it to the sensing responder.

Alternatively, in the embodiment of the present disclosure, the SBP request frame also carries parameter information of the TB sensing measurement. The SBP responder is instructed to set up the TB sensing measurement based on the parameter information.

Alternatively, in the embodiment of the present disclosure, the electronic device further includes:
a first receiving module, configured to, after the SBP request sending module 801 sends the SBP request frame to the SBP responder,
receive an SBP response frame sent by the SBP responder and obtain the target time information carried in the SBP response frame; where the SBP response frame is sent by the SBP responder before or after setting up the TB sensing measurement.

Alternatively, in the embodiment of the present disclosure, in a case where the SBP request frame includes multiple TB sensing measurements, the MS request frame includes the target time information corresponding to each TB sensing measurement.

The present disclosure embodiment also provides a sensing measurement setup device, which is applied to a sensing by proxy SBP initiator, and the device includes:
an SBP request frame sending module, configured to send an SBP request frame to an SBP responder, carry available time information of TB sensing measurement in the SBP request frame, instruct the SBP responder to select target time information from the available time information and carry the target time information in a measurement setup MS request frame and send it to a sensing responder.

The device also includes other modules of the electronic device in the aforementioned embodiment, which will not be repeated here.

Referring to FIG. 9, based on the same principle as the method provided in the embodiment of the present disclosure, the embodiment of the present disclosure also provides an electronic device. The electronic device is a sensing responder, and the electronic device includes:
a MS request receiving module 901, configured to receive a measurement setup MS request frame sent by an SBP responder; where the MS request frame includes target time information for participating in TB sensing measurement, and the target time information is selected by the SBP responder from available time information provided by an SBP initiator.

Alternatively, in the embodiment of the present disclosure, in a case where the SBP request frame includes multiple TB sensing measurements, the MS request frame includes target time information corresponding to each TB sensing measurement.

The embodiment of the present disclosure also provides a sensing measurement setup device, which is applied to a sensing responder, and the device includes:
a MS request frame receiving module configured to receive a measurement setup MS request frame sent by an SBP responder; where the MS request frame includes target time information for participating in TB sensing measurement, and the target time information is selected by the SBP responder from available time information provided by an SBP initiator.

The device also includes other modules of the electronic device in the aforementioned embodiment, which will not be repeated here.

In an embodiment, the embodiment of the present disclosure further provides an electronic device, as shown in FIG. 10. The electronic device 1000 shown in FIG. 10 may be a server, including: a processor 1001 and a memory 1003. The processor 1001 and the memory 1003 are connected, for example, through a bus 1002. Alternatively, the electronic device 1000 may also include a transceiver 1004. It should be noted that in actual applications, the transceiver 1004 is not limited to one, and the structure of the electronic device 1000 does not constitute a limitation on the embodiment of the present disclosure.

The processor 1001 may be a CPU (Central Processing Unit), a general-purpose processor, a DSP (Digital Signal Processor), an ASIC (Application Specific Integrated Circuit), an FPGA (Field Programmable Gate Array) or other programmable logic devices, transistor logic devices, hardware components or any combination thereof. It may implement or execute various example logic blocks, modules and circuits described in conjunction with the contents disclosed in the present disclosure. Processor 1001 may also be a combination that implements computing functions, such as a combination of one or more microprocessors, a combination of DSP and microprocessor, etc.

Bus 1002 may include a path to transmit information between the above components. Bus 1002 may be a PCI (Peripheral Component Interconnect) bus or an EISA (Extended Industry Standard Architecture) bus, etc. Bus 1002 may be classified into an address bus, a data bus, a control bus, etc. For ease of representation, only one thick line is used in FIG. 10, but it does not mean that there is only one bus or one type of bus.

The memory 1003 may be a ROM (Read Only Memory) or other types of static storage devices that can store static information and instructions, a RAM (Random Access Memory) or other types of dynamic storage devices that can store information and instructions, or an EEPROM (Electrically Erasable Programmable Read Only Memory), a CD-ROM (Compact Disc Read Only Memory) or other optical disk storage, optical disk storage (including compressed optical disk, laser disk, optical disk, digital versatile disk, Blu-ray disk, etc.), a disk storage medium or other magnetic storage device, or any other medium that can be configured to carry or store the desired program code in the form of instructions or data structures and can be accessed by a computer, but is not limited thereto.

The memory 1003 is configured to store the application code for executing the solutions of the present disclosure, and is controlled by the processor 1001 for execution. The processor 1001 is configured to execute the application code stored in the memory 1003 to implement the content shown in the aforementioned method embodiment.

Electronic devices include but are not limited to: mobile phones, laptops, digital broadcast receivers, PDAs (personal digital assistants), PADs (tablet computers), PMPs (portable multimedia players), vehicle-mounted terminals (such as vehicle-mounted navigation terminals), etc., and fixed terminals such as digital TVs, desktop computers, etc. The electronic device shown in FIG. 10 is only an example and should not impose any restrictions on the functions and scope of use of the embodiments of the present disclosure.

The server provided in the present disclosure may be an independent physical server, or a server cluster or distributed system composed of multiple physical servers, or a cloud server that provides basic cloud computing services such as cloud services, cloud databases, cloud computing, cloud functions, cloud storage, network services, cloud communications, middleware services, domain name services, security services, CDN, and big data and artificial intelligence platforms. The terminal may be a smart phone, a tablet computer, a laptop computer, a desktop computer, a smart speaker, a smart watch, etc., but is not limited thereto. The terminal and the server may be directly or indirectly connected via wired or wireless communication, which is not limited in the present disclosure.

The embodiments of the present disclosure provide a computer-readable storage medium, which stores a computer program, and when the computer program is run on a computer, the computer can execute the corresponding content in the aforementioned method embodiments.

It should be understood that although the steps in the flowchart of the accompanying drawings are displayed in sequence as indicated by the arrows, these steps are not necessarily executed in the order indicated by the arrows. Unless otherwise specified herein, the execution of these steps is not strictly limited in order, and they can be executed in other orders. Moreover, at least part of the steps in the flowchart of the accompanying drawings may include multiple sub-steps or multiple stages, and these sub-steps or stages are not necessarily executed at the same time, but can be executed at different time, and their execution order is not necessarily sequential, but can be executed in turn or alternately with other steps or at least part of the sub-steps or stages of other steps.

It should be noted that the above-mentioned computer-readable medium of the present disclosure may be a computer-readable signal medium or a computer-readable storage medium or any combination of the above two. The computer-readable storage medium may be, for example, but not limited to, an electrical, magnetic, optical, electromagnetic, infrared, or semiconductor system, device or device, or any combination of the above. More specific examples of computer-readable storage media may include, but are not limited to, an electrical connection with one or more conductors, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, a computer-readable storage medium may be any tangible medium containing or storing a program that can be used by or in conjunction with an instruction execution system, apparatus, or device. In the present disclosure, a computer-readable signal medium may include a data signal propagated in a baseband or as part of a carrier wave, which carries a computer-readable program code. Such propagated data signals may take a variety of forms, including but not limited to electromagnetic signals, optical signals, or any suitable combination of the above. A computer-readable signal medium may also be any computer-readable medium other than a computer-readable storage medium, which may send, propagate, or transmit a program for use by or in conjunction with an instruction execution system, apparatus, or device. The program code contained on a computer-readable medium may be transmitted using any appropriate medium, including but not limited to: wires, optical cables, RF (radio frequency), etc., or any suitable combination of the above.

The above-mentioned computer-readable medium may be included in the above-mentioned electronic device; or it may exist independently without being assembled into the electronic device.

The above-mentioned computer-readable medium carries one or more programs. When the above-mentioned one or more programs are executed by the electronic device, the electronic device executes the method shown in the above-mentioned embodiment.

According to one aspect of the present disclosure, a computer program product or computer program is provided, and the computer program product or computer program includes computer instructions, and the computer instructions are stored in a computer-readable storage medium. The processor of the computer device reads the computer instructions from the computer-readable storage medium, and the processor executes the computer instructions, so that the computer device executes the methods provided in the above-mentioned various optional implementations.

The computer program code for performing the operations of the present disclosure can be written in one or more programming languages or a combination thereof, and the above-mentioned programming languages include object-oriented programming languages—such as Java, Smalltalk, C++, and also conventional procedural programming languages—such as “C” language or similar programming languages. The program code can be executed completely on the user's computer, partially on the user's computer, as an independent software package, partially on the user's computer and partially on a remote computer, or completely on a remote computer or server. In cases involving a remote computer, the remote computer may be connected to the user computer through any type of network, including a local area network (LAN) or a wide area network (WAN), or may be connected to an external computer (e.g., through the Internet using an Internet service provider).

The flowcharts and block diagrams in the accompanying drawings illustrate the possible architecture, functions, and operations of the systems, methods, and computer program products according to various embodiments of the present disclosure. In this regard, each box in the flowchart or block diagram may represent a module, a program segment, or a portion of a code, which contains one or more executable instructions for implementing the specified logical functions. It should also be noted that in some alternative implementations, the functions marked in the box may also occur in an order different from that marked in the accompanying drawings. For example, two boxes represented in succession may actually be executed substantially in parallel, and they may sometimes be executed in the opposite order, depending on the functions involved. It should also be noted that each box in the block diagram and/or flowchart, and the combination of boxes in the block diagram and/or flowchart, can be implemented by a dedicated hardware-based system that performs the specified function or operation, or can be implemented by a combination of dedicated hardware and computer instructions.

The modules involved in the embodiments described in the present disclosure can be implemented by software or by hardware. The name of the module does not constitute a limitation on the module itself in some cases. For example, module A can also be described as “module A for performing operation B”.

The above description is only an explanation for example embodiments of the present disclosure and the technical principles used. Those skilled in the art should understand that the scope of disclosure involved in the present disclosure is not limited to the technical solutions formed by a specific combination of the above technical features, but also should cover other technical solutions formed by any combination of the above technical features or their equivalent features without departing from the above disclosure concept. For example, the above features are replaced with the technical features with similar functions disclosed in the present disclosure (but not limited to).

1. A sensing measurement setup method, comprising:
sending, by a sensing by proxy (SBP) responder, a measurement setup (MS) request frame to a sensing responder, wherein the MS request frame comprises target time information for participating in triggered based (TB) sensing measurement, and the target time information is selected by the SBP responder from available time information provided by an SBP initiator.

2. The sensing measurement setup method according to claim 1, further comprising:
receiving an SBP request frame sent by the SBP initiator; and
acquiring the available time information from the SBP request frame.

3. The sensing measurement setup method according to claim 2, further comprising:
acquiring parameter information of the TB sensing measurement comprised in the SBP request frame; and
setting up the TB sensing measurement based on the parameter information of the TB sensing measurement and determining the MS request frame.

4. The sensing measurement setup method according to claim 3, further comprising:
sending an SBP response frame to the SBP initiator, wherein the SBP response frame comprises the target time information.

5. The sensing measurement setup method according to claim 2, wherein in a case where the SBP request frame comprises a plurality of the TB sensing measurements, the MS request frame comprises the target time information corresponding to each of the TB sensing measurements.

6. A sensing measurement setup method, performed by a sensing by proxy (SBP) initiator, comprising:
sending an SBP request frame to an SBP responder;
carrying available time information of triggered based (TB) sensing measurement in the SBP request frame; and
instructing the SBP responder to select target time information from the available time information and carry the target time information in a measurement setup (MS) request frame and send it to a sensing responder.

7. The sensing measurement setup method according to claim 6, wherein the SBP request frame further comprises parameter information of the TB sensing measurement, and the SBP responder is instructed to set up the TB sensing measurement based on the parameter information of the TB sensing measurement.

8. The sensing measurement setup method according to claim 7, further comprising:
receiving an SBP response frame sent by the SBP responder; and
obtaining the target time information comprised in the SBP response frame.

9. The sensing measurement setup method according to claim 7, wherein in a case where the SBP request frame comprises a plurality of the TB sensing measurements, the MS request frame comprises the target time information corresponding to each of TB sensing measurements.

10. A sensing measurement setup method, comprising:
receiving, by a sensing responder, a measurement setup (MS) request frame sent by a sensing by proxy (SBP) responder, wherein the MS request frame comprises target time information for participating in triggered based (TB) sensing measurement, and the target time information is selected by the SBP responder from available time information provided by an SBP initiator.

11. The sensing measurement setup method according to claim 10, wherein in a case where an SBP request frame sent by the SBP initiator comprises a plurality of the TB sensing measurements, the MS request frame comprises the target time information corresponding to each of TB sensing measurements.

12-14. (canceled)

15. An electronic device, comprising:
a memory;
a processor; and
a computer program stored in the memory and executable on the processor, wherein the processor implements the method according to claim 1 when executing the computer program.

16. A non-transitory computer-readable storage medium, on which a computer program is stored, wherein the computer program implements the method according to claim 1 when executed by a processor.

17. An electronic device, comprising:
a memory;
a processor; and
a computer program stored in the memory and executable on the processor, wherein the processor implements the method according to claim 6 when executing the computer program.

18. An electronic device, comprising:
a memory;
a processor; and
a computer program stored in the memory and executable on the processor, wherein the processor implements the method according to claim 10 when executing the computer program.

19. A non-transitory computer-readable storage medium, on which a computer program is stored, wherein the computer program implements the method according to claim 6 when executed by a processor.

20. A non-transitory computer-readable storage medium, on which a computer program is stored, wherein the computer program implements the method according to claim 10 when executed by a processor.
